(19) United States
(12) Patent Application Publication
(10) Pub. No.: US 2026/0341791 A1
(43) Pub. Date: Oct. 29, 2026

(54) SECONDARY BATTERY AND ELECTRONIC APPARATUS

(71) Applicant: Ningde Amperex Technology Limited, Ningde (CN)

(72) Inventors: Junhua JIAN, Ningde (CN); Qi JIANG, Ningde (CN); Xianhai LU, Ningde (CN); Chao TANG, Ningde (CN)

(73) Assignee: Ningde Amperex Technology Limited, Ningde (CN)

(21) Appl. No.: 19/634,154

(22) Filed: Mar. 31, 2026

(30) Foreign Application Priority Data
Apr. 18, 2025 (CN) 202510489889.2

(51) Int. Cl. H01M 10/0567; H01M 10/0525; H01M 10/0569

(52) U.S. Cl. CPC H01M 10/0567; H01M 10/0525; H01M 10/0569; H01M 2300/0028

(57) ABSTRACT

An electrolyte solution includes a Formula I compound, and based on a mass of the electrolyte solution, a mass percentage of the Formula I compound is W₁%, where 2≤W₁≤50. The negative electrode sheet includes a negative electrode current collector and a negative electrode material layer disposed on at least one surface of the negative electrode current collector. The negative electrode material layer contains silicon element, and based on a mass of the negative electrode material layer, a mass percentage of the silicon element is x %, where x≤25. A thickness of the negative electrode material layer is D μm, a surface of the negative electrode material layer is provided with a plurality of recesses, and a depth of the recess is d μm, where P=d/D, P≥0.1, and 0.4≤W₁/(x×P)≤62.5.

### CROSS-REFERENCE TO RELATED APPLICATION

The present application claims priority to Chinese Patent application No. 202510489889.2 filed in the China National Intellectual Property Administration on Apr. 18, 2025, the entire content of which is hereby incorporated by reference.

### TECHNICAL FIELD

The present application relates to the field of electrochemical technology, and in particular to a secondary battery and an electronic apparatus.

### BACKGROUND

Secondary batteries, such as lithium-ion batteries, have significant advantages such as high energy density, miniaturization, and light weight, and are widely used in mobile phones, notebook computers, tablet computers, drones, electric vehicles, electric tools, power storage systems, and the like. Typically, a lithium-ion battery consists of a positive electrode sheet, a negative electrode sheet, and an electrolyte solution, where the electrolyte solution is responsible for maintaining ion transport between the positive electrode sheet and the negative electrode sheet, and also for maintaining a stable interface to enable stable operation of the lithium-ion battery. Currently, users have increasingly high requirements for the performance of secondary batteries, such as low-temperature charging capability and high-temperature storage performance. Therefore, there is an urgent need to provide a secondary battery with good low-temperature charging capability and high-temperature storage performance to meet the increasingly high usage demands of people.

### SUMMARY

A purpose of the present application is to provide a secondary battery and an electronic apparatus to improve the low-temperature charging capability and high-temperature storage performance of the secondary battery. The specific technical solution is as follows:

It should be noted that in the summary of the present application, a lithium-ion battery is used as an example of the secondary battery to explain the present application, but the secondary battery of the present application is not limited to lithium-ion batteries.

A first aspect of the present application provides a secondary battery including a negative electrode sheet and an electrolyte solution, the electrolyte solution including a Formula I compound:

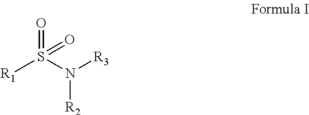

where R₁ is selected from a fluorine atom or a C₁ to C₅ alkyl group that is fully or partially substituted by fluorine, R₂ and R₃ are each independently selected from a C₁ to C₅ alkyl group, and R₂ and R₃ are able to be connected into a ring through a single bond; based on a mass of the electrolyte solution, a mass percentage of the Formula I compound is W₁%, and 2≤W₁≤50; the negative electrode sheet includes a negative electrode current collector and a negative electrode material layer disposed on at least one surface of the negative electrode current collector; the negative electrode material layer contains silicon element, based on a mass of the negative electrode material layer, a mass percentage of the silicon element is x %, and x≤25; a thickness of the negative electrode material layer is D μm, a surface of the negative electrode material layer is provided with a plurality of recesses, a depth of the recess is d μm, a depth of the recess relative to the negative electrode material layer is P, P=d/D, P≥0.1, and 0.4≤W₁/(x×P)≤62.5. By synergistically controlling the mass percentage of the Formula I compound in the electrolyte solution and the mass percentage of the silicon element in the negative electrode material layer, the toughness and stability of the solid electrolyte solution interphase film can be improved, thereby improving the high-temperature stability of the secondary battery. By synergistically controlling the mass percentage of the Formula I compound in the electrolyte solution and the depth of the recess relative to the negative electrode material layer, channels for electrolyte solution flow in the negative electrode sheet can be enriched, the flow of the electrolyte solution can be accelerated, and the wettability of the electrolyte solution to the negative electrode sheet can be improved. Additionally, the stability of the electrolyte solution system can be improved, the oxidative decomposition and heat release of other organic solvents in the electrolyte solution can be reduced, and the self-heat generation of the secondary battery can be reduced, thereby improving the low-temperature charging capability and high-temperature storage performance of the secondary battery. By synergistically controlling the mass percentage of the silicon element in the negative electrode material layer and the depth of the recess relative to the negative electrode material layer, the mechanical strength of the negative electrode sheet can be enhanced, thereby improving the high-temperature stability of the secondary battery. In the present application, by adjusting the values of W₁, x, P, and W₁/(x×P) within the ranges of the present application, the low-temperature charging capability and high-temperature storage performance of the secondary battery can be improved, while the energy density is relatively high.

In some embodiments of the present application, 5≤W₁≤30, and preferably 10≤W₁≤20. Adjusting the value of W₁ within the above range helps to further improve the low-temperature charging capability and high-temperature storage performance of the secondary battery.

In some embodiments of the present application, the Formula I compound includes at least one of the following compounds:

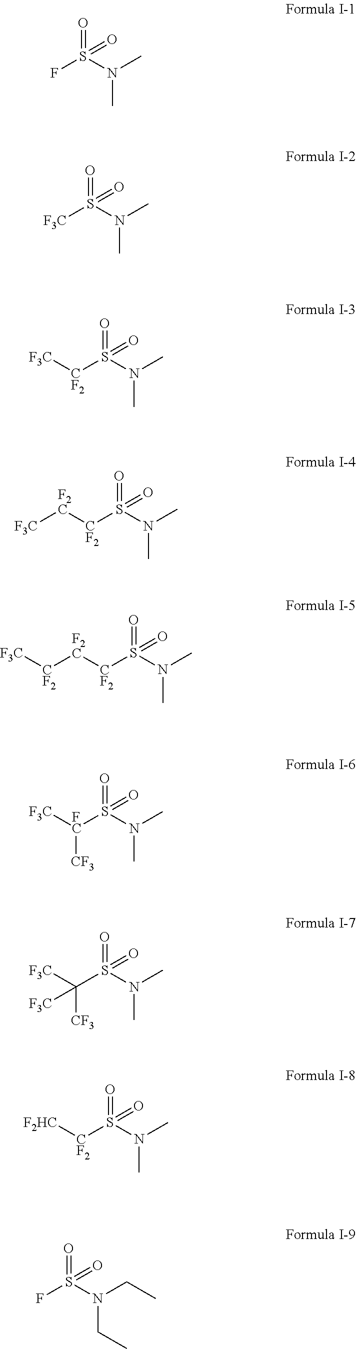

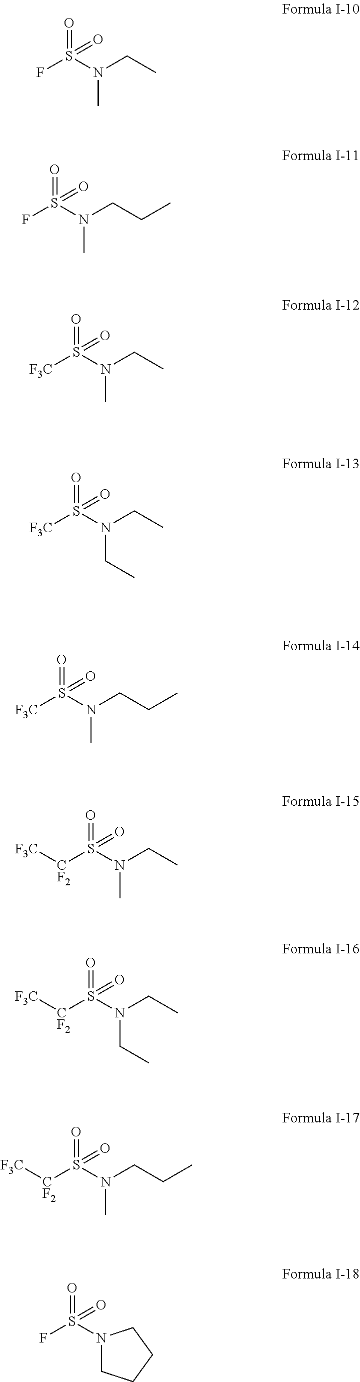

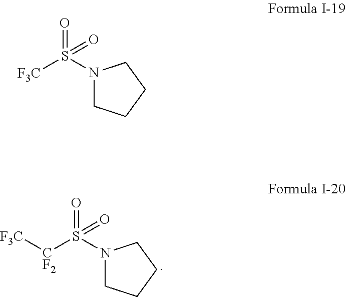 [SMILES: O=S(=O)(N1CCCC1)C(F)(F)F ; O=S(=O)(N1CCCC1)C(F)(F)C(F)(F)F]

The above compounds represented by Formula I have good high-temperature stability, and exert a synergistic function with the negative electrode sheet, helping to further improve the low-temperature charging capability and high-temperature storage performance of the secondary battery. When the electrolyte solution includes the Formula I compound, a more stable electrolyte solution system can be provided, the oxidative decomposition and heat release of other organic solvents in the electrolyte solution can be reduced, the self-heat generation of the secondary battery can be reduced, the thermal runaway temperature threshold can be increased, thereby helping to further improve the safety performance of the secondary battery.

In some embodiments of the present application, a minimum distance between two adjacent recesses is L μm, where 50≤L≤300. By adjusting the value of L within the scope of the present application, the recesses can have an appropriate distribution density, facilitating the processing and preparation of the secondary battery, and the recesses can better exert their functions, thereby helping to improve the low-temperature charging capability of the secondary battery, while the high-temperature storage performance and safety performance are good.

In some embodiments of the present application, 0.05≤W₁/L≤0.25. By adjusting the value of W₁/L within the scope of the present application, the electrolyte solution including the Formula I compound exerts a synergistic function with the negative electrode sheet, helping to improve the low-temperature charging capability, high-temperature storage performance, and safety performance of the secondary battery.

In some embodiments of the present application, 100≤D≤400. Adjusting the value of D within the scope of the present application helps to increase the volume energy density of the secondary battery, and also helps to improve the low-temperature charging capability of the secondary battery, while the high-temperature storage performance and safety performance are good.

In some embodiments of the present application, 0.1≤P≤0.5. Adjusting the value of P within the scope of the present application helps to increase the volume energy density of the secondary battery, and also helps to improve the low-temperature charging capability and high-temperature storage performance of the secondary battery.

In some embodiments of the present application, 4≤x≤25. Adjusting the value of x within the scope of the present application helps to increase the volume energy density of the secondary battery, and also helps to improve the low-temperature charging capability and high-temperature storage performance of the secondary battery.

In some embodiments of the present application, when observed along a thickness direction of the negative electrode sheet, the recess is a quadrilateral, and a length of a shortest side of the quadrilateral is D1 mm, where 0.02≤D1≤0.5. By adjusting the value of D1 within the scope of the present application, the negative electrode sheet has good processing and preparation performance, and exerts a synergistic function with the electrolyte solution including the Formula I compound, helping to improve the low-temperature charging capability of the secondary battery, while the high-temperature storage performance and safety performance are good.

In some embodiments of the present application, when observed along the thickness direction of the negative electrode sheet, the recess is a quadrilateral, a sum of areas of the quadrilaterals is S1 mm², and an area of the negative electrode material layer is S2 mm², where 0.1≤S1/S2≤0.8. By adjusting the value of S1/S2 within the scope of the present application, the area proportion of the recesses can be within an appropriate range, helping to exert the functions of the recesses, thereby helping to improve the low-temperature charging capability of the secondary battery, while the high-temperature storage performance and safety performance are good.

In some embodiments of the present application, the electrolyte solution further includes a first component, and the first component includes at least one of fluoroethylene carbonate, difluoroethylene carbonate, vinylene carbonate, and ethylene vinylene carbonate; and based on the mass of the electrolyte solution, a mass percentage of the first component is W₂%, where 0.5≤W₂≤15, and preferably 1≤W₂≤8. An electrolyte solution including the above types of first component is used, and adjusting the mass percentage W₂% of the first component within the above range helps to improve the low-temperature charging capability, high-temperature storage performance, and safety performance of the secondary battery.

A second aspect of the present application provides an electronic apparatus including the secondary battery in any of the above embodiments. The electronic apparatus of the present application has good usage performance.

### Beneficial Effects of the Present Application

The present application provides a secondary battery and an electronic apparatus. The secondary battery includes a negative electrode sheet and an electrolyte solution. The electrolyte solution includes a Formula I compound, and based on a mass of the electrolyte solution, a mass percentage of the Formula I compound is W₁%, where 2≤W₁≤50. The negative electrode sheet includes a negative electrode current collector and a negative electrode material layer disposed on at least one surface of the negative electrode current collector. The negative electrode material layer contains silicon element, and based on a mass of the negative electrode material layer, a mass percentage of the silicon element is x %, where x≤25. A thickness of the negative electrode material layer is D μm, a surface of the negative electrode material layer is provided with a plurality of recesses, a depth of the recess is d μm, and a depth of the recess relative to the negative electrode material layer is P, where P=d/D, P≥0.1, and 0.4≤W₁/(x×P)≤62.5. By synergistically controlling the mass percentage of the Formula I compound in the electrolyte solution and the mass percentage of the silicon element in the negative electrode material layer, the toughness and stability of the solid electrolyte solution interphase film can be improved, thereby improving the high-temperature stability of the secondary battery. By synergistically controlling the mass percentage of the Formula I compound in the electrolyte solution and the depth of the recess relative to the negative electrode material layer, channels for electrolyte solution flow in the negative electrode sheet can be enriched, the flow of the electrolyte solution can be accelerated, the wettability of the electrolyte solution to the negative electrode sheet can be improved. Additionally, the stability of the electrolyte solution system can be improved, the oxidative decomposition and heat release of other organic solvents in the electrolyte solution can be reduced, and the self-heat generation of the secondary battery can be reduced, thereby improving the low-temperature charging capability and high-temperature storage performance of the secondary battery. By synergistically controlling the mass percentage of the silicon element in the negative electrode material layer and the depth of the recess relative to the negative electrode material layer, the mechanical strength of the negative electrode sheet can be enhanced, thereby improving the high-temperature stability of the secondary battery. In the present application, by adjusting the values of W₁, x, P, and W₁/(x×P) within the ranges of the present application, the low-temperature charging capability and high-temperature storage performance of the secondary battery can be improved, while the energy density is relatively high.

Certainly, implementing any product or method of the present application does not necessarily need to achieve all the above-mentioned advantages simultaneously.

### DESCRIPTION OF DRAWINGS

To more clearly illustrate the technical solutions in some embodiments of the present application, the drawings to be used in the description of these embodiments will be briefly introduced below. Obviously, the drawings described below are only some embodiments of the present application. For those of ordinary skill in the art, other embodiments can also be obtained based on these drawings.

FIG. 1 is a schematic structural diagram of a negative electrode sheet along its thickness direction according to an embodiment of the present application;

FIG. 2 is a schematic structural diagram of a single-sided negative electrode material layer according to an embodiment of the present application; and

FIG. 3 is a schematic structural diagram of a single-sided negative electrode material layer according to another embodiment of the present application.

### REFERENCE SIGNS

negative electrode sheet 100, negative electrode current collector 110, negative electrode material layer 120, and recess 121.

### DETAILED DESCRIPTION OF EMBODIMENTS

The technical solutions in the present application will be clearly and completely described below in conjunction with some embodiments of the present application and the accompanying drawings. Obviously, the described embodiments are only some embodiments of the present application, rather than all embodiments. All other embodiments obtained by those of ordinary skill in the art based on the present application fall within the protection scope of the present application.

It should be noted that in the specific embodiments of the present application, a lithium-ion battery is used as an example of the secondary battery to explain the present application, but the secondary battery of the present application is not limited to lithium-ion batteries. The specific technical solution is as follows:

A first aspect of the present application provides a secondary battery including a negative electrode sheet and an electrolyte solution, the electrolyte solution including a Formula I compound:

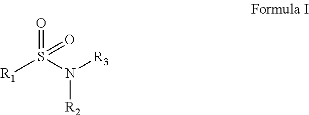

where R₁ is selected from a fluorine atom or a C₁ to C₅ alkyl group that is fully or partially substituted by fluorine, R₂ and R₃ are each independently selected from a C₁ to C₅ alkyl group, and R₂ and R₃ are able to be connected into a ring through a single bond. Based on a mass of the electrolyte solution, a mass percentage of the Formula I compound is W₁%, where 2≤W₁≤50, preferably 5≤W₁≤30, and more preferably 10≤W₁≤20. For example, the value of W₁ may be 2, 5, 8, 10, 11, 12, 13, 14, 15, 16, 17, 18, 19, 20, 22, 25, 28, 30, 32, 35, 38, 40, 42, 45, 48, 50, or in a range composed of any two of these values. The negative electrode sheet includes a negative electrode current collector and a negative electrode material layer disposed on at least one surface of the negative electrode current collector. The negative electrode material layer contains silicon element, and based on a mass of the negative electrode material layer, a mass percentage of the silicon element is x %, where x≤25, and preferably 4≤x≤25. For example, the value of x may be 4, 6, 8, 10, 12, 14, 15, 17, 18, 19, 20, 22, 25, or in a range composed of any two of these values. A thickness of the negative electrode material layer is D μm, a surface of the negative electrode material layer is provided with a plurality of recesses, and a depth of the recess is d μm, where P=d/D, P≥0.1, and preferably 0.1≤P≤0.5. For example, the value of P may be 0.10, 0.15, 0.20, 0.25, 0.30, 0.35, 0.40, 0.45, 0.50, or in a range composed of any two of these values. 0.4≤W₁/(x×P)≤62.5, for example, the value of W₁/(x×P) may be 0.4, 2, 5, 8, 10, 15, 20, 25, 30, 35, 40, 45, 50, 55, 60, 62.5, or in a range composed of any two of these values.

The negative electrode material layer of the present application contains silicon element, and the mass percentage x % of the silicon element in the negative electrode material layer is adjusted within the scope of the present application. The silicon element may come from silicon-based particles, and the silicon-based particles have a high specific capacity, which can increase the energy density of the secondary battery. The Formula I compound included in the electrolyte solution has a relatively low highest occupied molecular orbital (HOMO orbital energy level), thus having good oxidation resistance, which can reduce gas generation during high-temperature storage of the secondary battery, and improve the high-temperature stability of the electrolyte solution. Additionally, the Formula I compound has good interface compatibility with silicon-based materials, also has appropriate lithium ion solvation capability, good solubility to lithium salts, and is easier to desolvate during the process of lithium ion embedding and de-embedding at the interface, thereby improving the high-temperature storage performance of the secondary battery. However, the Formula I compound usually has a relatively large viscosity, and when the electrolyte solution includes the Formula I compound, it affects its fluidity and the wettability to the positive electrode sheet and negative electrode sheet, thereby affecting the low-temperature charging capability of the secondary battery. In the present application, by providing a plurality of recesses on the surface of the negative electrode material layer and adjusting the value of P within the scope of the present application, flow channels for the electrolyte solution can be provided, the flow of the electrolyte solution can be accelerated, and the wettability of the electrolyte solution to the negative electrode sheet can be improved, thereby improving the low-temperature charging capability of the secondary battery. When the electrolyte solution includes the Formula I compound, a more stable electrolyte solution system can be provided, and the oxidative decomposition and heat release of other organic solvents in the electrolyte solution can be reduced. In this way, the electrolyte solution exerts a synergistic function with the negative electrode sheet of the present application, reducing the self-heat generation of the secondary battery, and increasing the thermal runaway temperature threshold, thereby improving the safety performance of the secondary battery. By synergistically controlling the mass percentage of the Formula I compound in the electrolyte solution and the mass percentage of the silicon element in the negative electrode material layer, the toughness and stability of the solid electrolyte solution interphase film can be improved, thereby improving the high-temperature stability of the secondary battery. By synergistically controlling the mass percentage of the Formula I compound in the electrolyte solution and the depth of the recess relative to the negative electrode material layer, channels for electrolyte solution flow in the negative electrode sheet can be enriched, the flow of the electrolyte solution can be accelerated, and the wettability of the electrolyte solution to the negative electrode sheet can be improved. Additionally, the stability of the electrolyte solution system can be improved, the oxidative decomposition and heat release of other organic solvents in the electrolyte solution can be reduced, and the self-heat generation of the secondary battery can be reduced, thereby improving the low-temperature charging capability and high-temperature storage performance of the secondary battery. By synergistically controlling the mass percentage of the silicon element in the negative electrode material layer and the depth of the recess relative to the negative electrode material layer, the mechanical strength of the negative electrode sheet can be enhanced, thereby improving the high-temperature stability of the secondary battery. In the present application, by adjusting the values of W₁, x, P, and W₁/(x×P) within the ranges of the present application, the low-temperature charging capability and high-temperature storage performance of the secondary battery can be improved, while the energy density is relatively high. In the present application, low temperature refers to a temperature less than or equal to 0° C., and high temperature refers to a temperature greater than or equal to 45° C.

When the value of W₁ is too small, for example less than 2, the content of the Formula I compound is too low, the gas generation during high-temperature storage of the secondary battery is relatively large, the oxidative decomposition and heat release of other organic solvents in the electrolyte solution is relatively high, the wettability of the electrolyte solution to the positive electrode sheet and negative electrode sheet is relatively poor, and the effect of improving the high-temperature storage performance, low-temperature charging capability, and safety performance of the secondary battery is relatively poor. When the value of W₁ is too large, for example greater than 50, the content of the Formula I compound is too high, the viscosity of the electrolyte solution is too large, and the wettability to the positive electrode sheet and negative electrode sheet is relatively poor, affecting the low-temperature charging capability and high-temperature storage performance of the secondary battery. When the value of x is too large, for example greater than 25, the expansion after lithium embedding of the negative electrode material layer is large, affecting the high-temperature storage performance, low-temperature charging capability, and safety performance of the secondary battery. When the value of P is too small, for example less than 0.1, the effect of improving the fluidity of the electrolyte solution and the wettability to the negative electrode sheet is relatively poor, affecting the low-temperature charging capability and high-temperature storage performance of the secondary battery. When the value of W₁/(x×P) is too small, for example less than 0.4, it is difficult to exert the synergistic function of the electrolyte solution with the negative electrode sheet, the Formula I compound is difficult to act on the recesses on the surface of the negative electrode material layer, and the improvement in the low-temperature charging capability, high-temperature storage performance, and safety performance of the secondary battery is insignificant. When the value of W₁/(x×P) is too large, for example greater than 62.5, the Formula I compound is prone to excessive reaction in the recesses on the surface of the negative electrode material layer, the wettability of the electrolyte solution to the positive electrode sheet and negative electrode sheet is relatively poor, and the energy density of the secondary battery is too low, affecting the low-temperature charging capability, high-temperature storage performance, and safety performance of the secondary battery.

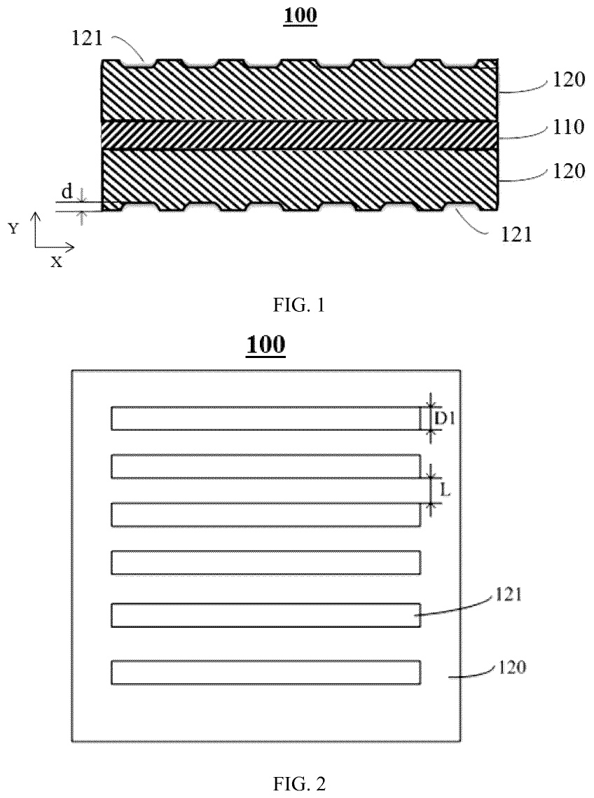

Exemplarily, as shown in FIG. 1, the length direction of the negative electrode sheet itself is defined as X, and the thickness direction itself is defined as Y. The negative electrode sheet usually has a long side and a short side, and the above length direction is the extension direction of the long side of the negative electrode sheet. It should be understood that the above definition of directions is for the purpose of facilitating the description of the present application. The negative electrode sheet 100 includes a negative electrode current collector 110 and a negative electrode material layer 120 disposed on both surfaces of the negative electrode current collector 110, the thickness of the negative electrode material layer 120 is D μm, the surface of the negative electrode material layer 120 is provided with a plurality of recesses 121, and the depth of the recess 121 is d μm.

In some embodiments, R₁ is selected from a fluorine atom, difluoromethyl, trifluoromethyl, tetrafluoroethyl, pentafluoroethyl, heptafluoropropyl, or nonafluorobutyl; R₂ is selected from methyl, ethyl, propyl, or butyl; and R₃ is selected from methyl, ethyl, propyl, or butyl. The electrolyte solution includes the Formula I compound containing groups within the above range, helping to improve the low-temperature charging capability, high-temperature storage performance, and safety performance of the secondary battery.

In some embodiments of the present application, the Formula I compound includes at least one of the following compounds:

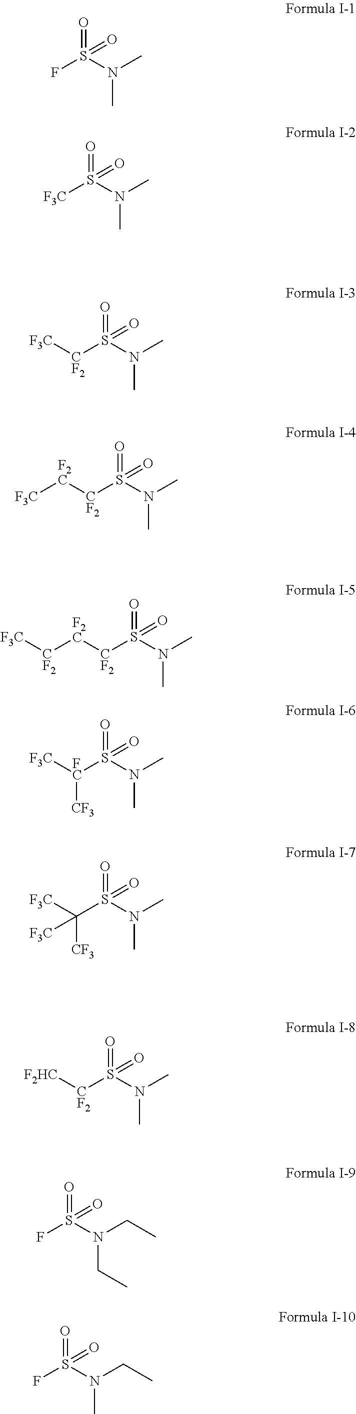

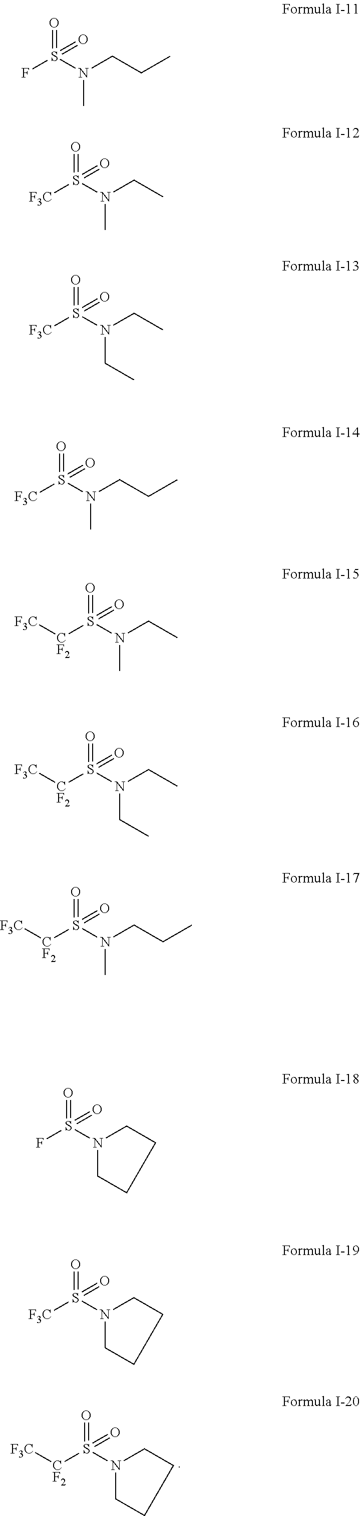

The above compounds represented by Formula I have good high-temperature stability, good interface compatibility with silicon-based materials, and appropriate lithium ion solvation capability, while having good solubility to lithium salts, and are easier to desolvate during the process of lithium ion embedding and de-embedding at the interface, thereby helping to further improve the high-temperature storage performance of the secondary battery. When the electrolyte solution includes the above Formula I compound, a more stable electrolyte solution system can be provided, reducing the oxidative decomposition and heat release of other organic solvents in the electrolyte solution, reducing the self-heat generation of the secondary battery, and increasing the thermal runaway temperature threshold, thereby helping to further improve the safety performance of the secondary battery.

In some embodiments of the present application, a minimum distance between two adjacent recesses is L μm, where 50≤L≤300. For example, the value of L may be 50, 80, 100, 120, 150, 180, 200, 220, 250, 280, 300, or in a range composed of any two of these values. By adjusting the value of L within the scope of the present application, the recesses can have an appropriate distribution density, facilitating the processing and preparation of the secondary battery, and better exerting the function of the recesses and the synergistic function with the electrolyte solution including the Formula I compound, thereby helping to improve the low-temperature charging capability of the secondary battery, while the high-temperature storage performance and safety performance are good. In the present application, the minimum distance between two adjacent recesses may be the same or different, as long as the purpose of the present application can be achieved.

In some embodiments of the present application, 0.05≤W₁/L≤0.25. For example, the value of W₁/L may be 0.05, 0.08, 0.10, 0.12, 0.15, 0.18, 0.20, 0.22, 0.25, or in a range composed of any two of these values. By adjusting the value of W₁/L within the scope of the present application, the electrolyte solution including the Formula I compound exerts a synergistic function with the negative electrode sheet, helping to accelerate the flow of the electrolyte solution, and improve the wettability of the electrolyte solution to the positive electrode sheet and negative electrode sheet. Additionally, this adjustment ensures good high-temperature stability of the electrolyte solution, reducing the oxidative decomposition and heat release of other organic solvents in the electrolyte solution, reducing the self-heat generation of the secondary battery, and increasing the thermal runaway temperature threshold, thereby helping to improve the low-temperature charging capability, high-temperature storage performance, and safety performance of the secondary battery.

In some embodiments of the present application, 100≤D≤400. For example, the value of D may be 100, 120, 150, 180, 200, 220, 250, 270, 300, 320, 350, 380, 400, or in a range composed of any two of these values. Adjusting the value of D within the scope of the present application helps to increase the volume energy density of the secondary battery, while the kinetic performance of the secondary battery is good, thereby helping to improve the low-temperature charging capability of the secondary battery and allowing for good high-temperature storage performance and safety performance.

In some embodiments, 10≤d≤200. For example, the value of d may be 10, 20, 30, 40, 50, 60, 80, 100, 120, 140, 160, 180, 200, or in a range composed of any two of these values.

In some embodiments of the present application, when observed along a thickness direction of the negative electrode sheet, the recess is a quadrilateral, and a length of a shortest side of the quadrilateral is D1 mm, where 0.02≤D1≤0.5. For example, the value of D1 may be 0.02, 0.10, 0.15, 0.20, 0.25, 0.30, 0.35, 0.40, 0.45, 0.50, or in a range composed of any two of these values. By adjusting the value of D1 within the scope of the present application, the negative electrode sheet has good processing and preparation performance, helping to accelerate the flow of the electrolyte solution and improve the wettability of the electrolyte solution to the positive electrode sheet and negative electrode sheet, and can exert a synergistic function with the electrolyte solution including the Formula I compound, thereby helping to improve the low-temperature charging capability of the secondary battery, while the high-temperature storage performance and safety performance are good.

In the present application, the plurality of recesses may be distributed in a stripe shape, a plurality of recesses may be provided along the width direction of the negative electrode sheet, a plurality of recesses may be provided along the length direction of the negative electrode sheet, or a plurality of recesses may be provided simultaneously along the width direction and length direction of the negative electrode sheet. In the present application, when the plurality of recesses are distributed in a stripe shape, the widths of the stripes of the orthographic projections of two adjacent recesses may be the same or different, the length D1 of the shortest side of the quadrilateral is the maximum value of the above orthographic projection widths, and the lengths of the stripes may be the same or different, as long as the purpose of the present application can be achieved. The present application has no particular limitation on the length of the stripes, which can be designed according to the size of the negative electrode sheet, as long as the purpose of the present application can be achieved.

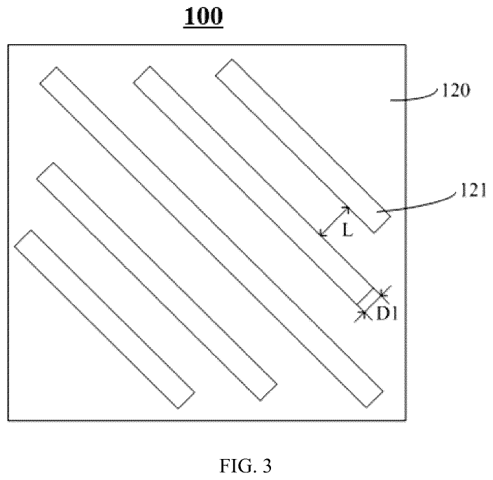

Specifically, in some embodiments, as shown in FIG. 2, the surface of the negative electrode material layer 120 is provided with a plurality of recesses 121, the plurality of recesses 121 are distributed in a stripe shape, and one side of the orthographic projection of a single recess 121 is parallel to one side of the negative electrode sheet 100. The shape of the orthographic projection of a single recess 121 is a narrow and long rectangle, the width of the rectangle is D1, and the minimum spacing between adjacent rectangles is L. In some other embodiments, as shown in FIG. 3, the plurality of recesses 121 are distributed in a stripe shape, and there is an included angle between one side of the orthographic projection of a single recess 121 and one side of the negative electrode sheet 100. The shape of the orthographic projection of a single recess 121 is a narrow and long rectangle, the width of the rectangle is D1, the minimum spacing between adjacent rectangles is L, and the lengths of adjacent rectangles are different. The present application has no particular limitation on the size of the above included angle, as long as the purpose of the present application can be achieved. Exemplarily, the included angle is 25° to 65°. The size, number, and shape of the recesses in FIGS. 2 and 3 are only examples and do not limit the protection scope of the present application.

In some embodiments of the present application, when observed along the thickness direction of the negative electrode sheet, the recess is a quadrilateral, a sum of areas of the quadrilaterals is S1 mm², and an area of the negative electrode material layer is S2 mm², where 0.1≤S1/S2≤0.8. For example, the value of S1/S2 may be 0.10, 0.15, 0.20, 0.25, 0.30, 0.35, 0.40, 0.45, 0.50, 0.55, 0.60, 0.65, 0.70, 0.75, 0.80, or in a range composed of any two of these values. By adjusting the value of S1/S2 within the scope of the present application, the area proportion of the recesses can be within an appropriate range, helping to exert the functions of the recesses, accelerate the flow of the electrolyte solution, and improve the wettability of the electrolyte solution to the positive electrode sheet and negative electrode sheet. In this way, the negative electrode sheet can exert a synergistic function with the electrolyte solution including the Formula I compound, helping to improve the low-temperature charging capability of the secondary battery, while the high-temperature storage performance and safety performance are good.

The present application has no particular limitation on the preparation method of the negative electrode sheet, as long as the purpose of the present application can be achieved. For example, the preparation of the negative electrode sheet may include but is not limited to the following steps: providing a negative electrode material layer on one surface of the negative electrode current collector, then repeating the provision of the negative electrode material layer on the other surface of the negative electrode current collector, and then etching recesses on the surface of the double-sided negative electrode material layer through a laser process to obtain the negative electrode sheet. The present application has no particular limitation on the manner of adjusting d, L, D1, and S1, as long as the purpose of the present application can be achieved. For example, the sizes of d, L, D1, and S1 can be adjusted by adjusting the parameters of the laser process.

In some embodiments of the present application, the electrolyte solution further includes a first component, and the first component includes at least one of fluoroethylene carbonate, difluoroethylene carbonate, vinylene carbonate, and ethylene vinylene carbonate. Using an electrolyte solution including the above types of first component helps to form a denser SEI film on the negative electrode surface, reduce side reactions between the negative electrode active material and the electrolyte solution, make the secondary battery have a longer cycle life, and improve the cycling stability of the secondary battery. In this way, the electrolyte solution can exert a synergistic function with the negative electrode sheet, helping to improve the low-temperature charging capability, high-temperature storage performance, and safety performance of the secondary battery.

In some embodiments of the present application, based on the mass of the electrolyte solution, the mass percentage of the first component is W₂%, where 0.5≤W₂≤15, and preferably 1≤W₂≤8. For example, the value of W₂ may be 0.5, 0.7, 1, 2, 3, 4, 5, 6, 7, 8, 9, 10, 11, 12, 13, 14, 15, or in a range composed of any two of these values. Adjusting the mass percentage W₂% of the first component within the above range helps to form a denser SEI film on the negative electrode surface, reduce side reactions between the negative electrode active material and the electrolyte solution, make the secondary battery have a longer cycle life, and improve the cycling stability of the secondary battery. In this way, the electrolyte solution can exert a synergistic function with the negative electrode sheet, helping to improve the low-temperature charging capability, high-temperature storage performance, and safety performance of the secondary battery.

In the present application, the electrolyte solution further includes a lithium salt and other non-aqueous solvents. The present application has no particular limitation on the lithium salt, as long as the purpose of the present application can be achieved. For example, the lithium salt may include but is not limited to at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalato) borate (LiBOB), or lithium difluoro (oxalato) borate. The present application has no particular limitation on the content of the lithium salt in the electrolyte solution, as long as the purpose of the present application can be achieved. For example, based on the mass of the electrolyte solution, the mass percentage of the lithium salt is 8% to 30%.

The present application has no particular limitation on other non-aqueous solvents, as long as the purpose of the present application can be achieved, for example, other non-aqueous solvents may include but are not limited to at least one of carbonate compounds, carboxylate compounds, ether compounds, or other organic solvents.

The above carbonate compounds may include but are not limited to at least one of chain carbonate compounds, cyclic carbonate compounds, or fluorocarbonate compounds. The above chain carbonate compounds may include but are not limited to at least one of dimethyl carbonate (DMC), diethyl carbonate (DEC), dipropyl carbonate (DPC), methyl propyl carbonate (MPC), ethyl propyl carbonate (EPC), or methyl ethyl carbonate (MEC). The above cyclic carbonate compounds may include but are not limited to at least one of ethylene carbonate (EC), propylene carbonate (PC), or butylene carbonate (BC). The fluorocarbonate compounds may include but are not limited to at least one of carbonic acid-1,2-difluoroethylene ester, carbonic acid-1,1-difluoroethylene ester, carbonic acid-1,1,2-trifluoroethylene ester, carbonic acid-1,1,2,2-tetrafluoroethylene ester, carbonic acid-1-fluoro-2-methyl ethylene ester, carbonic acid-1-fluoro-1-methyl ethylene ester, carbonic acid-1,2-difluoro-1-methyl ethylene ester, carbonic acid-1,1,2-trifluoro-2-methyl ethylene ester, or carbonic acid trifluoromethyl ethylene ester. The above carboxylate compounds may include but are not limited to at least one of methyl formate, methyl acetate, ethyl acetate, n-propyl acetate, tert-butyl acetate, methyl propionate, ethyl propionate, propyl propionate, γ-butyrolactone, decanolide, valerolactone, or caprolactone. The above ether compounds may include but are not limited to at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The above other organic solvents may include but are not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. The present application has no particular limitation on the content of other non-aqueous solvents in the electrolyte solution, as long as the purpose of the present application can be achieved. For example, based on the mass of the electrolyte solution, the mass percentage of other non-aqueous solvents is 5% to 89.5%.

In some embodiments, the electrolyte solution may include the Formula I compound, a lithium salt, and other non-aqueous solvents, the mass percentages of the Formula I compound and the lithium salt are as described above, and the mass percentage of other non-aqueous solvents is 20% to 89.5%. The secondary battery including the above electrolyte solution has good low-temperature charging capability, high-temperature storage performance, and safety performance.

In some embodiments, the electrolyte solution may include the Formula I compound, a first component, a lithium salt, and other non-aqueous solvents, and the mass percentages of the Formula I compound, the first component, the lithium salt, and other non-aqueous solvents are as described above. The secondary battery including the above electrolyte solution has good low-temperature charging capability, high-temperature storage performance, and safety performance.

In the present application, the negative electrode sheet includes a negative electrode current collector and a negative electrode material layer disposed on at least one surface of the negative electrode current collector. The above “the negative electrode sheet includes a negative electrode current collector and a negative electrode material layer disposed on at least one surface of the negative electrode current collector” means that the negative electrode material layer may be disposed on one surface of the negative electrode current collector along its thickness direction, or may be disposed on both surfaces of the negative electrode current collector along its thickness direction. It should be noted that the “surface” here may be the entire region of the surface of the negative electrode current collector or a partial region of the surface of the negative electrode current collector, and the present application has no particular limitation, as long as the purpose of the present application can be achieved.

In the present application, the negative electrode material layer includes a negative electrode active material, the negative electrode active material includes silicon-based particles, and the silicon-based particles include at least one of pure silicon, silicon alloy, silicon-carbon composite material, or silicon-oxygen composite material (SiOₓ (0<x≤2)), where the silicon alloy may include at least one of lithium-silicon alloy, silicon-germanium alloy, silicon-tin alloy, or silicon-aluminum alloy.

In the present application, the mass percentage x % of the silicon element in the negative electrode material layer can be adjusted by adjusting the mass percentage of silicon-based particles in the negative electrode material layer and the mass percentage of silicon element in the silicon-based particles. For example, when other conditions are unchanged, a larger mass percentage of silicon-based particles in the negative electrode material layer indicates a larger x %; a smaller mass percentage of silicon-based particles in the negative electrode material layer indicates a smaller x %. When other conditions are unchanged, a larger mass percentage of silicon element in the silicon-based particles indicates a larger x %; a smaller mass percentage of silicon element in the silicon-based particles indicates a smaller x %.

The negative electrode material layer further includes a negative electrode active material other than silicon-based particles. The present application has no particular limitation on the type of negative electrode active material other than silicon-based particles, as long as the purpose of the present application can be achieved. For example, the negative electrode active material other than silicon-based particles may include at least one of natural graphite, artificial graphite, mesocarbon microbeads (MCMB), hard carbon, soft carbon, Li—Sn alloy, Li—Sn—O alloy, Sn, SnO, SnO₂, spinel-structured lithium titanate Li₄Ti₅O₁₂, Li—Al alloy, or metallic lithium.

The negative electrode material layer of the present application further includes a negative electrode conductive agent and a negative electrode binder. The present application has no particular limitation on the negative electrode conductive agent and negative electrode binder in the negative electrode material layer, as long as the purpose of the present application can be achieved. For example, the negative electrode conductive agent may include but is not limited to at least one of conductive carbon black, carbon nanotubes (CNTs), carbon fibers, flake graphite, graphene, metal materials, or conductive polymers, and the conductive carbon black may include but is not limited to at least one of acetylene black or Ketjen black. The above carbon nanotubes may include but are not limited to single-walled carbon nanotubes and/or multi-walled carbon nanotubes. The above carbon fibers may include but are not limited to vapor-grown carbon fibers (VGCF) and/or nano carbon fibers. The above metal materials may include but are not limited to metal powder and/or metal fibers. Specifically, the metal may include but is not limited to at least one of copper, nickel, aluminum, or silver. The above conductive polymers may include but are not limited to at least one of polyphenyl derivatives, polyaniline, polythiophene, polyacetylene, or polypyrrole. For example, the negative electrode binder may include but is not limited to at least one of polyacrylic acid, sodium polyacrylate, potassium polyacrylate, lithium polyacrylate, polyvinyl alcohol, carboxymethyl cellulose, sodium carboxymethyl cellulose, lithium carboxymethyl cellulose, polyimide, polyamideimide, butadiene styrene rubber, or polyvinylidene fluoride. The present application has no particular limitation on the mass ratio of the negative electrode active material, negative electrode conductive agent, and negative electrode binder in the negative electrode material layer. Those of ordinary skill in the art can select the mass ratio according to actual needs, as long as the purpose of the present application can be achieved.

The present application has no particular limitation on the negative electrode current collector, as long as the purpose of the present application can be achieved, for example, it may include copper foil, copper alloy foil, nickel foil, stainless steel foil, titanium foil, foamed nickel, foamed copper, or composite current collector. Exemplarily, the composite current collector may be lithium-copper composite current collector, carbon-copper composite current collector, nickel-copper composite current collector, or titanium-copper composite current collector. The present application has no particular limitation on the thickness of the negative electrode current collector, as long as the purpose of the present application can be achieved. For example, the thickness of the negative electrode current collector is 4 μm to 20 μm.

In the present application, the secondary battery further includes a positive electrode sheet. The positive electrode sheet includes a positive electrode current collector and a positive electrode material layer disposed on at least one surface of the positive electrode current collector. The above “positive electrode material layer disposed on at least one surface of the positive electrode current collector” means that the positive electrode material layer may be disposed on one surface of the positive electrode current collector along its thickness direction, or may be disposed on both surfaces of the positive electrode current collector along its thickness direction. It should be noted that the “surface” here may be the entire region of the positive electrode current collector or a partial region of the positive electrode current collector, and the present application has no particular limitation, as long as the purpose of the present application can be achieved.

The present application has no particular limitation on the positive electrode current collector, as long as the purpose of the present application can be achieved, for example, it may include aluminum foil, aluminum alloy foil, or composite current collector (such as aluminum-carbon composite current collector).

The positive electrode material layer of the present application includes a positive electrode active material, and the positive electrode active material includes a substance capable of reversibly embedding and de-embedding active ions such as lithium ions. One or more positive electrode material layers may be provided, and these positive electrode material layers may be made of the same or different positive electrode active materials. The present application has no particular limitation on the positive electrode active material, as long as the purpose of the present application can be achieved. For example, the positive electrode active material may include but is not limited to at least one of lithium nickel cobalt manganese oxide, lithium nickel cobalt aluminum oxide, lithium iron phosphate, lithium-rich manganese-based material, lithium cobaltate (LiCoO₂), lithium manganate, lithium iron manganese phosphate, or lithium titanate. The above lithium nickel cobalt manganese oxide may include at least one of LiNi_{0.95}Co_{0.03}Mn_{0.02}O₂(Ni95), LiNi_{0.91}Co_{0.03}Mn_{0.06}O₂(Ni91), LiNi_{0.8}CO_{0.1}Mn_{0.1}O₂(NCM811), LiNi_{0.6}Co_{0.2}Mn_{0.2}O₂(NCM622), LiNi_{0.5}Co_{0.2}Mn_{0.3}O₂ (NCM523), or LiNi_{1/3}Co_{1/3}Mn_{1/3}O₂(NCM111). In the present application, the positive electrode active material may further include non-metal elements, for example, the non-metal elements include at least one of fluorine, phosphorus, boron, chlorine, silicon, or sulfur.

The positive electrode material layer of the present application further includes a positive electrode conductive agent and a positive electrode binder. The present application has no particular limitation on the positive electrode conductive agent and positive electrode binder in the positive electrode material layer, as long as the purpose of the present application can be achieved. For example, the positive electrode conductive agent may be at least one of the above negative electrode conductive agents, and the positive electrode binder may be at least one of the above negative electrode binders. The present application has no particular limitation on the mass ratio of the positive electrode active material, positive electrode conductive agent, and positive electrode binder in the positive electrode material layer. Those of ordinary skill in the art can select according to actual needs, as long as the purpose of the present application can be achieved.

In the present application, there is no particular limitation on the thickness of the positive electrode current collector and the positive electrode material layer, as long as the purpose of the present application can be achieved. For example, the thickness of the positive electrode current collector is 5 μm to 20 μm, preferably 6 μm to 18 μm; the thickness of the single-sided positive electrode material layer is 30 μm to 120 μm.

In the present application, the secondary battery further includes a separator. The present application has no particular limitation on the separator, as long as the purpose of the present application can be achieved. For example, the material of the separator may include but is not limited to at least one of polyolefin (PO)-based mainly polyethylene (PE) and polypropylene (PP), polyester (for example, polyethylene terephthalate (PET) film), cellulose, polyimide (PI), polyamide (PA), spandex, or aramid. The type of the separator may include at least one of a woven film, a non-woven film, a microporous film, a composite film, a rolled film, or a spun film.

In some embodiments, the separator may include a substrate layer and a surface treatment layer. The substrate layer may be a non-woven film or composite film with a porous structure, and the material of the substrate layer may include at least one of polyethylene, polypropylene, polyethylene terephthalate, or polyimide. Optionally, a polypropylene microporous film, a polyethylene microporous film, a polypropylene non-woven fabric, a polyethylene non-woven fabric, or a polypropylene-polyethylene-polypropylene microporous composite film may be used.

Optionally, a surface treatment layer is provided on at least one surface of the substrate layer, and the surface treatment layer may be a polymer layer or an inorganic layer, or a layer formed by mixing a polymer and an inorganic material. In some embodiments, the inorganic layer includes inorganic particles and

an inorganic layer binder. The present application has no particular limitation on the inorganic particles, for example, the inorganic particles may include at least one of alumina, silica, magnesia, titania, hafnia, tin oxide, ceria, nickel oxide, zinc oxide, calcia, zirconia, yttria, silicon carbide, boehmite, aluminum hydroxide, magnesium hydroxide, calcium hydroxide, or barium sulfate. The present application has no particular limitation on the inorganic layer binder, for example, it may be at least one of the above negative electrode binders. In some embodiments, the polymer layer includes a polymer, and the material of the polymer includes at least one of polyamide, polyacrylonitrile, acrylate polymer, polyacrylic acid, polyacrylate, polyvinylpyrrolidone, polyvinyl ether, polyvinylidene fluoride, or poly(vinylidene fluoride-hexafluoropropylene).

In the present application, the thickness of the separator has no particular limitation, as long as the purpose of the present application can be achieved, for example, the thickness of the separator may be 3 μm to 30 μm.

The secondary battery further includes a housing for accommodating the positive electrode sheet, separator, negative electrode sheet, and electrolyte solution, as well as other components known in the field of secondary batteries. The present application has no limitation on the above other components. The present application has no particular limitation on the housing, which may be a housing known in the art, as long as the purpose of the present application can be achieved. For example, the housing may be a hard housing or a flexible housing. The material of the hard housing may be metal, the present application has no limitation on the type of metal, and metal hard housings known in the art may be used, as long as the purpose of the present application can be achieved. The flexible housing may be a metal plastic film, such as aluminum-plastic film or steel-plastic film.

The secondary battery of the present application has no particular limitation, and it may include any device in which an electrochemical reaction occurs. In some embodiments, the secondary battery may include but is not limited to: lithium-ion secondary battery (lithium-ion battery), lithium polymer secondary battery, or lithium-ion polymer secondary battery.

The preparation process of the secondary battery of the present application is well known to those of ordinary skill in the art, and the present application has no particular limitation. For example, the preparation process of the secondary battery may include but is not limited to the following steps: stacking the positive electrode sheet, separator, and negative electrode sheet in sequence, and performing winding, folding, or other operations as needed to obtain a wound electrode assembly, placing the electrode assembly into the housing, injecting the electrolyte solution into the housing and sealing it, to obtain the secondary battery. Alternatively, the positive electrode sheet, separator, and negative electrode sheet are stacked in sequence, then the four corners of the entire laminated structure are fixed with tape to obtain a laminated electrode assembly, the electrode assembly is placed into the housing, and the electrolyte solution is injected into the housing and sealed, to obtain the secondary battery. In addition, an overcurrent prevention element, a guide plate, and the like may be placed in the housing as needed, thereby preventing pressure rise inside the secondary battery and overcharge and overdischarge.

A second aspect of the present application provides an electronic apparatus including the secondary battery in any of the above embodiments. The electronic apparatus of the present application has good usage performance.

The present application has no particular limitation on the type of electronic apparatus, which may be any electronic apparatus known in the prior art. In some embodiments, the electronic apparatus may include but is not limited to notebook computers, pen-input computers, mobile computers, e-book players, portable phones, portable facsimile machines, portable copiers, portable printers, stereo headphones, video recorders, liquid crystal televisions, portable cleaners, portable CD players, mini discs, transceivers, electronic organizers, calculators, memory cards, portable recorders, radios, backup power sources, motors, automobiles, motorcycles, power-assisted bicycles, bicycles, lighting fixtures, toys, game consoles, clocks, electric tools, flashlights, cameras, household large-scale storage batteries, and lithium-ion capacitors.

### EXAMPLES

Hereinafter, examples and comparative examples are given to more specifically illustrate some embodiments of the present application. Various tests and evaluations were conducted according to the following methods. In addition, unless otherwise specified, “parts” and “%” are on a mass basis.

### Test Methods and Equipment:

Test for a mass percentage x % of silicon element based on a mass of a negative electrode material layer

A scanning electron microscope (SEM) was used in backscattering mode to observe the surface of the negative electrode sheet perpendicular to the thickness direction, and an energy dispersive X-ray spectrometer (EDS) was used to scan the above surface of the negative electrode sheet to obtain the mass percentage x % of the silicon element based on the mass of the negative electrode material layer.

### Test for d, L, D, D1, and S1/S2

The cross-section of the negative electrode sheet along the thickness direction was ion-polished to obtain the cross-section of the negative electrode sheet, and observed and measured under a scanning electron microscope to obtain the depth d of the recess and the thickness D of the negative electrode material layer. Ten values were measured respectively and averaged to obtain d and D.

Under a VHX5000 microscope, the magnification was set to 50 to 200 times, the surface of the negative electrode material layer was observed along the thickness direction of the negative electrode sheet and photographed, the area of the negative electrode material layer in the photo was recorded as S2, and the sum of the areas of the quadrilaterals (when observed along the thickness direction of the negative electrode sheet, the recess is a quadrilateral) in the photo was recorded as S1. The length of the shortest side of the quadrilaterals in the photo was recorded as D1, and the minimum distance between two adjacent quadrilaterals was recorded as L.

### Low-Temperature Charging Capability Test

The lithium-ion battery was transferred to a 0° C. constant temperature box, placed for 120 min, then charged at a constant current of 1C to 4.5 V, then charged at a constant voltage of 4.5 V to 0.025C, rested for 5 minutes, then discharged at a constant current of 0.5C to 3 V, and rested for 60 minutes. After 10 cycles, the lithium-ion battery was charged at a constant current of 1C to 4.5 V, the lithium-ion battery was disassembled to obtain the negative electrode sheet, and the lithium precipitation on the surface of the negative electrode sheet was observed.

Lithium precipitation degree determination: The lithium precipitation degree was determined based on the state of the negative electrode sheet under full charge disassembly conditions. The non-lithium precipitated region on the surface of the negative electrode sheet was golden yellow, and the lithium precipitated region was gray. Based on the total area of the single-sided negative electrode material layer, when the entire negative electrode sheet was golden yellow and the gray area was less than 1%, it was determined as no lithium precipitation. When most of the negative electrode sheet was golden yellow, but some regions were gray, and the gray area was equal to or greater than 1% and less than 10%, it was determined as slight lithium precipitation. When part of the negative electrode sheet had significant gray, but some regions were still observable as golden yellow, and the gray area was equal to or greater than 10% and less than 50%, it was determined as moderate lithium precipitation. When most of the negative electrode sheet was gray, and the gray area was equal to or greater than 50%, it was determined as severe lithium precipitation.

### High-Temperature Storage Performance Test

The lithium-ion battery was placed in a 25° C. constant temperature environment and left standing for 30 min, such that the lithium-ion battery reaches a constant temperature. Then the lithium-ion battery was charged at a constant current of 0.7C to 4.5 V, and then charged at a constant voltage of 4.5 V until the current was 0.025C, and the thickness of the lithium-ion battery was recorded as the initial thickness. The lithium-ion battery was transferred to a 60° C. constant temperature box and stored for 30 days, during which the thickness of the lithium-ion battery was tested and recorded every 6 days, and the test thickness after 30 days was recorded as the storage thickness. The thickness expansion rate of the lithium-ion battery was calculated and used as an indicator to evaluate the amount of gas generated during high-temperature storage of the lithium-ion battery. High-temperature storage thickness expansion rate (%)=(storage thickness−initial thickness)/initial thickness×100%.

### Example 1-1

### <Preparation of Electrolyte Solution>

In an argon atmosphere glove box with a water content of less than 10 ppm, diethyl carbonate and ethylene carbonate were mixed in a mass ratio of 1:1 to obtain a base solvent, and then the Formula I compound, Formula I-1, and lithium salt lithium hexafluorophosphate (LiPF₆) were added to the base solvent and mixed well to obtain the electrolyte solution. Based on the mass of the electrolyte solution, the mass percentage of the lithium salt LiPF₆ was 12.5%, the mass percentage W₁% of the Formula I compound was as shown in Table 1, and the balance was the base solvent.

### <Preparation of Negative Electrode Sheet>

Negative electrode active material silicon-carbon composite material, negative electrode active material artificial graphite, negative electrode conductive agent acetylene black, and negative electrode binder butadiene styrene rubber were mixed in a mass ratio of 37.5:59.9:1.4:1.2, deionized water was added as a solvent, and they were adjusted to form a slurry with a solid content of 45 wt %. The slurry was stirred well with a vacuum mixer to obtain a negative electrode slurry. The negative electrode slurry was uniformly applied to one surface of a 6 μm thick negative electrode current collector copper foil, and dried at 120° C. to obtain a negative electrode sheet coated with the negative electrode material layer on a single surface. Then the above steps were repeated on the other surface of the copper foil to obtain a negative electrode sheet coated with the negative electrode material layer on two surfaces. After drying at 120° C. and cold pressing, recesses were etched on the surface of the double-sided negative electrode material layer by laser processing technology, followed by slitting and tab welding, to obtain a negative electrode sheet with a specification of 78 mm×875 mm for later use. The compaction density of the negative electrode material layer was 1.7 g/cm³, and the thickness D of the negative electrode material layer, the depth d of the recess, the minimum distance L between two adjacent recesses, D1, S1/S2, and x % were as shown in Table 1.

### <Preparation of Positive Electrode Sheet>

Positive electrode active material lithium cobaltate, positive electrode conductive agent conductive carbon black (Super P), and positive electrode binder polyvinylidene fluoride (PVDF) were mixed in a mass ratio of 97:1.4:1.6, N-methylpyrrolidone (NMP) was added as a solvent, and they were adjusted to form a slurry with a solid content of 75 wt %. The slurry was stirred well with a vacuum mixer to obtain a positive electrode slurry. The positive electrode slurry was uniformly applied to one surface of a 10 μm thick positive electrode current collector aluminum foil, dried at 85° C. to obtain a positive electrode sheet coated with a positive electrode material layer on a single surface. Then the above steps were repeated on the other surface of the positive electrode sheet to obtain a positive electrode sheet coated with the positive electrode material layer on two surfaces. After coating, the positive electrode sheet was cold pressed, followed by slitting and tab welding, to obtain a positive electrode sheet with a specification of 74 mm×867 mm for later use. The coating weight of the single-sided positive electrode material layer was 411 mg/1540 mm², and the thickness of the single-sided positive electrode material layer was 72.4 μm.

### <Separator>

A 7 μm thick polyethylene (PE) film was used.

### <Preparation of Lithium-Ion Battery>

The above-prepared positive electrode sheet, separator, and negative electrode sheet were stacked in sequence, with the separator placed between the positive electrode sheet and the negative electrode sheet to play a separation role, and then wound to obtain an electrode assembly. The electrode assembly was placed into an aluminum-plastic film packaging shell, and dried in an 85° C. vacuum oven for 12 h to remove moisture. The above-prepared electrolyte solution was injected, and after vacuum packaging, standing, formation (constant current charging at 0.02C to 3.5 V, then constant current charging at 0.1C to 3.9 V), shaping, capacity testing, and other processes, a lithium-ion battery was obtained.

### Example 1-2 to Example 1-24

Except for adjusting the relevant preparation parameters according to Table 1, the rest were the same as those in Example 1-1. When the mass percentage W₁% of the Formula I compound changed, the mass percentage of the base solvent changed accordingly, the proportion of each component in the base solvent remained unchanged, and the mass percentage of the lithium salt LiPF₆ remained unchanged. The mass percentage x % of the silicon element in the negative electrode material layer was adjusted by adjusting the mass percentage of the silicon element in the silicon-based particles; and d, L, D1, and S1/S2 were adjusted by adjusting the process conditions of the laser processing treatment.

### Example 2-1

Except that the <preparation of electrolyte solution> adopted the following preparation method, the rest were the same as those in Example 1-1.

### <Preparation of Electrolyte Solution>

In an argon atmosphere glove box with a water content of less than 10 ppm, diethyl carbonate and ethylene carbonate were mixed in a mass ratio of 1:1 to obtain a base solvent, and then the Formula I compound, Formula I-1, the first component fluoroethylene carbonate, and lithium salt lithium hexafluorophosphate (LiPF₆) were added to the base solvent and mixed well to obtain the electrolyte solution. Based on the mass of the electrolyte solution, the mass percentage W₁% of the Formula I compound was 15%, the mass percentage W₂% of the first component fluoroethylene carbonate was 0.5%, the mass percentage of the lithium salt LiPF₆ was 12.5%, and the balance was the base solvent.

### Example 2-2 to Example 2-8

Except for adjusting the relevant preparation parameters according to Table 2, the rest were the same as those in Example 2-1. When the mass percentage W₂% of the first component changed, the mass percentage of the base solvent changed accordingly, the proportion of each component in the base solvent remained unchanged, and the mass percentages of the Formula I compound and the lithium salt LiPF₆ remained unchanged.

### Comparative Example 1 to Comparative Example 6

Except for adjusting the relevant preparation parameters according to Table 1, the rest were the same as those in Example 1-1. When the mass percentage W₁% of the Formula I compound changed, the mass percentage of the base solvent changed accordingly, the proportion of each component in the base solvent remained unchanged, and the mass percentage of the lithium salt LiPF₆ remained unchanged. The mass percentage x % of the silicon element in the negative electrode material layer was adjusted by adjusting the mass percentage of the silicon element in the silicon-based particles; and d was adjusted by adjusting the process conditions of the laser processing treatment.

### Comparative Example 7

Except that the <preparation of electrolyte solution> adopted the following preparation method, the rest were the same as those in Example 1-1.

### <Preparation of Electrolyte Solution>

In an argon atmosphere glove box with a water content of less than 10 ppm, diethyl carbonate and ethylene carbonate were mixed in a mass ratio of 1:1 to obtain a base solvent, and then the Formula I compoundI and lithium salt lithium hexafluorophosphate (LiPF₆) were added to the base solvent and mixed well to obtain the electrolyte solution. Based on the mass of the electrolyte solution, the mass percentage of the lithium salt LiPF₆ was 12.5%, the mass percentage of the Formula I compoundI was 15%, and the balance was the base solvent.

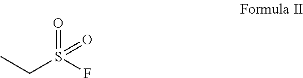

### Comparative Example 8

Except that in the <preparation of negative electrode sheet>, no laser processing treatment was performed to obtain a negative electrode sheet with no recesses on the surface of the negative electrode material layer, the rest were the same as Example 1-1.

The preparation parameters and performance parameters of each example and comparative example are shown in Tables 1 and 2.

TABLE 1

| | | | | | | | | | | | | | High- |
|---|---|---|---|---|---|---|---|---|---|---|---|---|---|
| | | | | | | | | | | | | Low- | temperature |
| | | | | | | | | | | | | temperature | storage |
| | | | | | | | | | | | | charging lithium | thickness |
| | Formula I | W₁ | x | D | d | | W₁/ | L | | D1 | | precipitation | expansion |
| | compound | (%) | (%) | (μm) | (μm) | P | (x × P) | (μm) | W₁/L | (mm) | S1/S2 | situation | rate (%) |
| Example 1-1 | Formula I- | 15 | 15 | 150 | 30 | 0.2 | 5.0 | 100 | 0.15 | 0.2 | 0.5 | No lithium | 25 |
| | 1 | | | | | | | | | | | precipitation | |
| Example 1-2 | Formula I- | 2 | 15 | 150 | 30 | 0.2 | 0.7 | 100 | 0.02 | 0.2 | 0.5 | Slight lithium | 32 |
| | 1 | | | | | | | | | | | precipitation | |
| Example 1-3 | Formula I- | 5 | 15 | 150 | 30 | 0.2 | 1.7 | 100 | 0.05 | 0.2 | 0.5 | Slight lithium | 31 |
| | 1 | | | | | | | | | | | precipitation | |
| Example 1-4 | Formula I- | 10 | 15 | 150 | 30 | 0.2 | 3.3 | 100 | 0.1 | 0.2 | 0.5 | No lithium | 30 |
| | 1 | | | | | | | | | | | precipitation | |
| Example 1-5 | Formula I- | 20 | 15 | 150 | 30 | 0.2 | 6.7 | 100 | 0.2 | 0.2 | 0.5 | No lithium | 23 |
| | 1 | | | | | | | | | | | precipitation | |
| Example 1-6 | Formula I- | 30 | 15 | 150 | 30 | 0.2 | 10.0 | 100 | 0.3 | 0.2 | 0.5 | Slight lithium | 25 |
| | 1 | | | | | | | | | | | precipitation | |
| Example 1-7 | Formula I- | 50 | 15 | 150 | 30 | 0.2 | 16.7 | 100 | 0.5 | 0.2 | 0.5 | Moderate | 27 |
| | 1 | | | | | | | | | | | lithium | |
| | | | | | | | | | | | | precipitation | |
| Example 1-8 | Formula I- | 15 | 4 | 150 | 30 | 0.2 | 18.8 | 100 | 0.15 | 0.2 | 0.5 | No lithium | 23 |
| | 1 | | | | | | | | | | | precipitation | |
| Example 1-9 | Formula I- | 15 | 25 | 150 | 30 | 0.2 | 3.0 | 100 | 0.15 | 0.2 | 0.5 | No lithium | 27 |
| | 1 | | | | | | | | | | | precipitation | |
| Example 1- | Formula I- | 15 | 15 | 150 | 15 | 0.1 | 10.0 | 100 | 0.15 | 0.2 | 0.5 | No lithium | 29 |
| 10 | 1 | | | | | | | | | | | precipitation | |
| Example 1- | Formula I- | 15 | 15 | 150 | 75 | 0.5 | 2.0 | 100 | 0.15 | 0.2 | 0.5 | No lithium | 24 |
| 11 | 1 | | | | | | | | | | | precipitation | |
| Example 1- | Formula I- | 5 | 25 | 150 | 75 | 0.5 | 0.4 | 100 | 0.05 | 0.2 | 0.5 | No lithium | 29 |
| 12 | 1 | | | | | | | | | | | precipitation | |
| Example 1- | Formula I- | 25 | 4 | 150 | 15 | 0.1 | 62.5 | 100 | 0.25 | 0.2 | 0.5 | No lithium | 24 |
| 13 | 1 | | | | | | | | | | | precipitation | |
| Example 1- | Formula I- | 15 | 15 | 150 | 30 | 0.2 | 5.0 | 100 | 0.15 | 0.2 | 0.5 | No lithium | 26 |
| 14 | 2 | | | | | | | | | | | precipitation | |
| Example 1- | Formula I- | 15 | 15 | 150 | 30 | 0.2 | 5.0 | 100 | 0.15 | 0.2 | 0.5 | No lithium | 27 |
| 15 | 10 | | | | | | | | | | | precipitation | |
| Example 1- | Formula I- | 15 | 15 | 150 | 30 | 0.2 | 5.0 | 100 | 0.15 | 0.2 | 0.5 | No lithium | 26 |
| 16 | 19 | | | | | | | | | | | precipitation | |
| Example 1- | Formula I- | 15 | 15 | 150 | 30 | 0.2 | 5.0 | 50 | 0.3 | 0.2 | 0.5 | Slight lithium | 31 |
| 17 | 1 | | | | | | | | | | | precipitation | |
| Example 1- | Formula I- | 15 | 15 | 150 | 30 | 0.2 | 5.0 | 300 | 0.05 | 0.2 | 0.5 | No lithium | 28 |
| 18 | 1 | | | | | | | | | | | precipitation | |
| Example 1- | Formula I- | 15 | 15 | 100 | 20 | 0.2 | 5.0 | 100 | 0.15 | 0.2 | 0.5 | No lithium | 24 |
| 19 | 1 | | | | | | | | | | | precipitation | |
| Example 1- | Formula I- | 15 | 15 | 400 | 80 | 0.2 | 5.0 | 100 | 0.15 | 0.2 | 0.5 | No lithium | 27 |
| 20 | 1 | | | | | | | | | | | precipitation | |
| Example 1- | Formula I- | 15 | 15 | 150 | 30 | 0.2 | 5.0 | 100 | 0.15 | 0.02 | 0.5 | No lithium | 30 |
| 21 | 1 | | | | | | | | | | | precipitation | |
| Example 1- | Formula I- | 15 | 15 | 150 | 30 | 0.2 | 5.0 | 100 | 0.15 | 0.5 | 0.5 | No lithium | 26 |
| 22 | 1 | | | | | | | | | | | precipitation | |
| Example 1- | Formula I- | 15 | 15 | 150 | 30 | 0.2 | 5.0 | 100 | 0.15 | 0.2 | 0.1 | No lithium | 30 |
| 23 | 1 | | | | | | | | | | | precipitation | |
| Example 1- | Formula I- | 15 | 15 | 150 | 30 | 0.2 | 5.0 | 100 | 0.15 | 0.2 | 0.8 | No lithium | 26 |
| 24 | 1 | | | | | | | | | | | precipitation | |
| Comparative | Formula I- | 1.5 | 15 | 150 | 30 | 0.2 | 0.5 | 100 | 0.015 | 0.2 | 0.5 | Moderate | 38 |
| Example 1 | 1 | | | | | | | | | | | lithium | |
| | | | | | | | | | | | | precipitation | |
| Comparative | Formula I- | 55 | 15 | 150 | 30 | 0.2 | 18.3 | 100 | 0.55 | 0.2 | 0.5 | Severe lithium | 33 |
| Example 2 | 1 | | | | | | | | | | | precipitation | |
| Comparative | Formula I- | 15 | 28 | 150 | 30 | 0.2 | 2.7 | 100 | 0.15 | 0.2 | 0.5 | Severe lithium | 35 |
| Example 3 | 1 | | | | | | | | | | | precipitation | |
| Comparative | Formula I- | 15 | 15 | 150 | 7.5 | 0.0 | 20.0 | 100 | 0.15 | 0.2 | 0.5 | Moderate | 33 |
| Example 4 | 1 | | | | | 5 | | | | | | lithium | |
| | | | | | | | | | | | | precipitation | |
| Comparative | Formula I- | 2 | 25 | 150 | 75 | 0.5 | 0.2 | 100 | 0.02 | 0.2 | 0.5 | Moderate | 32 |
| Example 5 | 1 | | | | | | | | | | | lithium | |
| | | | | | | | | | | | | precipitation | |
| Comparative | Formula I- | 30 | 4 | 150 | 15 | 0.1 | 75.0 | 100 | 0.3 | 0.2 | 0.5 | Moderate | 34 |
| Example 6 | 1 | | | | | | | | | | | lithium | |
| | | | | | | | | | | | | precipitation | |
| Comparative | / | / | 15 | 150 | 30 | 0.2 | / | 100 | / | 0.2 | 0.5 | Severe lithium | 40 |
| Example 7 | | | | | | | | | | | | precipitation | |
| Comparative | Formula I- | 15 | 15 | 150 | / | / | / | / | / | / | / | Severe lithium | 35 |
| Example 8 | 1 | | | | | | | | | | | precipitation | |

Note:
“/” in Table 1 indicates no relevant preparation parameters.

From Example 1-1 to Example 1-24 and Comparative Example 1 to Comparative Example 8, it can be seen from the present application that by adjusting the values of W₁, x, P, and W₁/(x×P) within the ranges of the present application, the electrolyte solution exerts a synergistic function with the negative electrode sheet, the degree of lithium precipitation of the lithium-ion battery during low-temperature charging is smaller, and the high-temperature storage thickness expansion rate is smaller, indicating that the lithium-ion battery has good low-temperature charging capability and high-temperature storage performance. For the lithium-ion batteries of Comparative Example 1 to Comparative Example 6, any one of W₁, x, P, and W₁/(x×P) is not within the scope of the present application, the electrolyte solution of Comparative Example 7 does not include the Formula I compound, and the surface of the negative electrode material layer of Comparative Example 8 is not provided with recesses. For the lithium-ion batteries of Comparative Example 1 to Comparative Example 8, the degree of lithium precipitation during low-temperature charging is greater, and/or the high-temperature storage thickness expansion rate is greater, indicating that the lithium-ion battery cannot achieve both low-temperature charging capability and high-temperature storage performance.

The mass percentage W₁% of the Formula I compound affects the low-temperature charging capability and high-temperature storage performance of the lithium-ion battery. From Example 1-1 to Example 1-7 and Comparative Example 1 and Comparative Example 2, it can be seen that when the value of W₁ is too small, for example, in Comparative Example 1, the degree of lithium precipitation of the lithium-ion battery during low-temperature charging is greater, and the high-temperature storage thickness expansion rate is greater. When the value of W₁ is too large, for example, in Comparative Example 2, the degree of lithium precipitation of the lithium-ion battery during low-temperature charging is greater, and the high-temperature storage thickness expansion rate is greater, indicating that the lithium-ion battery cannot achieve both low-temperature charging capability and high-temperature storage performance. When the value of W₁ is within the scope of the present application, the degree of lithium precipitation of the lithium-ion battery during low-temperature charging is smaller, and the high-temperature storage thickness expansion rate is smaller, indicating that the lithium-ion battery has good low-temperature charging capability and high-temperature storage performance.

The mass percentage x % of the silicon element in the negative electrode material layer affects the low-temperature charging capability and high-temperature storage performance of the lithium-ion battery. From Example 1-1, Example 1-8, Example 1-9, and Comparative Example 3, it can be seen that when the value of x is too large, for example, in Comparative Example 3, the degree of lithium precipitation of the lithium-ion battery during low-temperature charging is greater, and the high-temperature storage thickness expansion rate is greater, indicating that the lithium-ion battery cannot achieve both low-temperature charging capability and high-temperature storage performance. When the value of x is within the scope of the present application, the degree of lithium precipitation of the lithium-ion battery during low-temperature charging is smaller, and the high-temperature storage thickness expansion rate is smaller, indicating that the lithium-ion battery has good low-temperature charging capability and high-temperature storage performance.

The P value affects the low-temperature charging capability and high-temperature storage performance of the lithium-ion battery. From Example 1-1, Example 1-10, Example 1-11, and Comparative Example 4, it can be seen that when the value of P is too small, for example, in Comparative Example 4, the degree of lithium precipitation of the lithium-ion battery during low-temperature charging is greater, and the high-temperature storage thickness expansion rate is greater, indicating that the lithium-ion battery cannot achieve both low-temperature charging capability and high-temperature storage performance. When the value of P is within the scope of the present application, the degree of lithium precipitation of the lithium-ion battery during low-temperature charging is smaller, and the high-temperature storage thickness expansion rate is smaller, indicating that the lithium-ion battery has good low-temperature charging capability and high-temperature storage performance.

W₁/(x×P) affects the low-temperature charging capability and high-temperature storage performance of the lithium-ion battery. From Example 1-1 to Example 1-13, Comparative Example 5, and Comparative Example 6, it can be seen that when the value of W₁/(x×P) is too small, for example, in Comparative Example 5, the degree of lithium precipitation of the lithium-ion battery during low-temperature charging is greater, and the high-temperature storage thickness expansion rate is greater. When the value of W₁/(x×P) is too large, for example, in Comparative Example 6, the degree of lithium precipitation of the lithium-ion battery during low-temperature charging is greater, and the high-temperature storage thickness expansion rate is greater, indicating that the lithium-ion battery cannot achieve both low-temperature charging capability and high-temperature storage performance. When the value of W₁/(x×P) is within the scope of the present application, the degree of lithium precipitation of the lithium-ion battery during low-temperature charging is smaller, and the high-temperature storage thickness expansion rate is smaller, indicating that the lithium-ion battery has good low-temperature charging capability and high-temperature storage performance.

The type of Formula I compound affects the low-temperature charging capability and high-temperature storage performance of the lithium-ion battery. From Example 1-1 and Example 1-14 to Example 1-16, it can be seen that with the use of the Formula I compound within the scope of the present application, the degree of lithium precipitation of the lithium-ion battery during low-temperature charging is smaller, and the high-temperature storage thickness expansion rate is smaller, indicating that the lithium-ion battery has good low-temperature charging capability and high-temperature storage performance.

The values of L, W₁/L, D, D1, and S1/S2 affect the low-temperature charging capability and high-temperature storage performance of the lithium-ion battery. From Example 1-1 and Example 1-17 to Example 1-24, it can be seen that when the values of L, W₁/L, D, D1, and S1/S2 are within the scope of the present application, the degree of lithium precipitation of the lithium-ion battery during low-temperature charging is smaller, and the high-temperature storage thickness expansion rate is smaller, indicating that the lithium-ion battery has good low-temperature charging capability and high-temperature storage performance.

TABLE 2

| | | | Low- | High- |
|---|---|---|---|---|
| | | | temperature | temperature |
| | | | charging | storage |
| | | | lithium | thickness |
| | | W₂ | precipitation | expansion |
| | First component | (%) | situation | rate (%) |
| Example 1-1 | / | 0 | No lithium | 25 |
| | | | precipitation | |
| Example 2-1 | Fluoroethylene | 0.5 | No lithium | 23 |
| | carbonate | | precipitation | |
| Example 2-2 | Fluoroethylene | 1 | No lithium | 20 |
| | carbonate | | precipitation | |
| Example 2-3 | Fluoroethylene | 5 | No lithium | 18 |
| | carbonate | | precipitation | |
| Example 2-4 | Fluoroethylene | 3 + 2 | No lithium | 16 |
| | carbonate + | | precipitation | |
| | vinylene carbonate | | | |
| Example 2-5 | Fluoroethylene | 8 | No lithium | 21 |
| | carbonate | | precipitation | |
| Example 2-6 | Fluoroethylene | 15 | No lithium | 24 |
| | carbonate | | precipitation | |
| Example 2-7 | Fluoroethylene | 18 | No lithium | 28 |
| | carbonate | | precipitation | |
| Example 2-8 | Vinylene carbonate | 5 | No lithium | 20 |
| | | | precipitation | |

Note:
(1) “/” in Table 2 indicates no relevant preparation parameters; and (2)

In Example 2-4, the “first component” is “fluoroethylene carbonate+vinylene carbonate”, and “W₂(%)” is “3+2”, indicating that the first component is fluoroethylene carbonate and vinylene carbonate, based on the total mass of the electrolyte solution, the mass percentage of fluoroethylene carbonate is 3%, and the mass percentage of vinylene carbonate is 2%.

The mass percentage W₂% of the first component affects the low-temperature charging capability and high-temperature storage performance of the lithium-ion battery. From Example 1-1 and Example 2-1 to Example 2-7, it can be seen that when the value of W₂ is within the scope of the present application, the degree of lithium precipitation of the lithium-ion battery during low-temperature charging is smaller, and the high-temperature storage thickness expansion rate is smaller, indicating that the lithium-ion battery has good low-temperature charging capability and high-temperature storage performance.

The type of the first component affects the low-temperature charging capability and high-temperature storage performance of the lithium-ion battery. From Example 2-1 and Example 2-8, it can be seen that with the use of the first component within the scope of the present application, the degree of lithium precipitation of the lithium-ion battery during low-temperature charging is smaller, and the high-temperature storage thickness expansion rate is smaller, indicating that the lithium-ion battery has good low-temperature charging capability and high-temperature storage performance.

It should be noted that in this article, relational terms such as first and second are only used to distinguish one entity or operation from another entity or operation, and do not necessarily require or imply any such actual relationship or sequence between these entities or operations. Moreover, the terms “include”, “contain” or any other variant thereof are intended to cover non-exclusive inclusion, such that a process, method or article of manufacture that includes a series of elements not only includes those elements, but also includes other elements not explicitly listed, or also includes elements inherent to such process, method or article of manufacture.

The various embodiments in this specification are described in a related manner, and the same or similar parts between the various embodiments can be referred to each other. Each embodiment focuses on the differences from other embodiments.

The above are only preferred embodiments of the present application and are not intended to limit the present application. Any modifications, equivalent substitutions, improvements, and the like made within the spirit and principles of the present application shall be included in the protection scope of the present application.

What is claimed is:

1. A secondary battery, comprising a negative electrode sheet and an electrolyte solution, wherein the electrolyte solution comprises a Formula I compound, the Formula I compound is 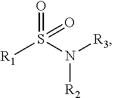
wherein
R₁ is selected from a fluorine atom or a C₁ to C₅ alkyl group that is fully or partially substituted by fluorine, R₂ and R₃ are each independently selected from a C₁ to C₅ alkyl group, and R₂ and R₃ are able to be connected into a ring through a single bond;
based on a mass of the electrolyte solution, a mass percentage of the Formula I compound is W₁%, and 2≤W₁≤50;
the negative electrode sheet comprises a negative electrode current collector and a negative electrode material layer disposed on at least one surface of the negative electrode current collector;
the negative electrode material layer contains silicon element, based on a mass of the negative electrode material layer, a mass percentage of the silicon element is x %, and x≤25;
a thickness of the negative electrode material layer is D μm, a surface of the negative electrode material layer is provided with a plurality of recesses, a depth of each recess is d μm, P=d/D, and P≥0.1; and
0.4≤W₁/(x×P)≤62.5.

2. The secondary battery according to claim 1, wherein 5≤W₁≤30.

3. The secondary battery according to claim 1, wherein 10≤W₁≤20.

4. The secondary battery according to claim 1, wherein the Formula I compound comprises at least one of the following compounds:

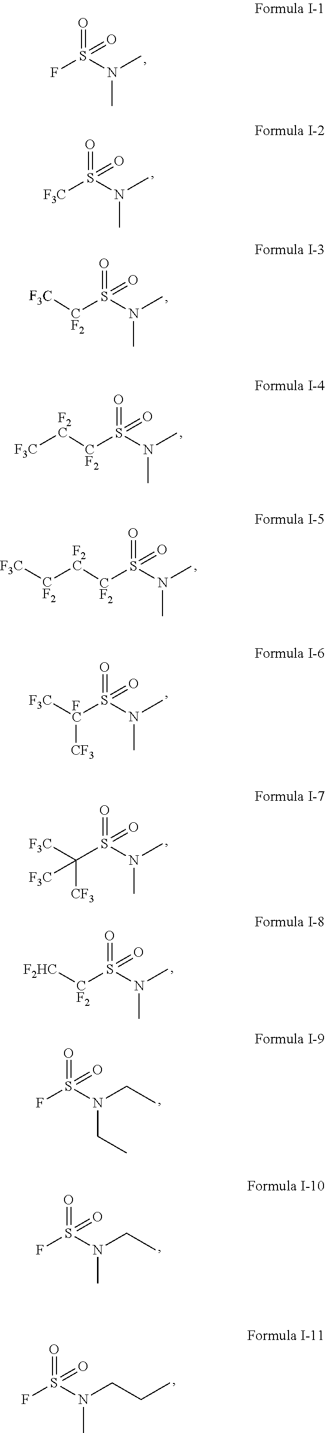

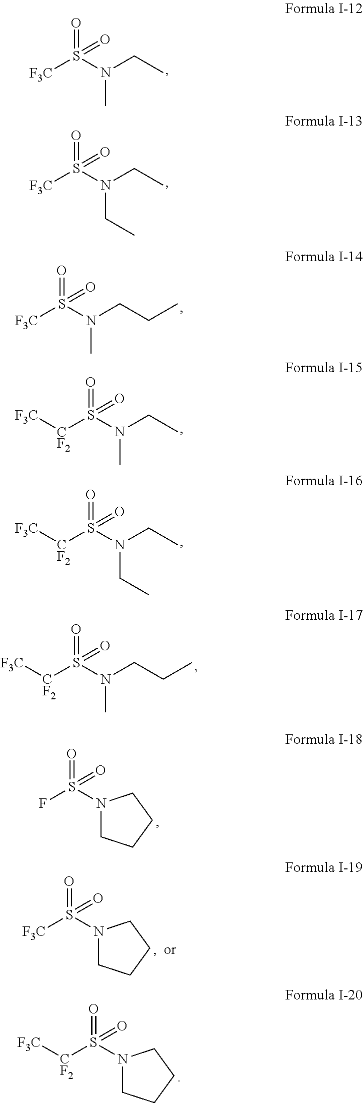

5. The secondary battery according to claim 1, wherein a minimum distance between two adjacent recesses is L μm, wherein 50≤L≤300.

6. The secondary battery according to claim 4, wherein 0.05≤W₁/L≤0.25.

7. The secondary battery according to claim 1, wherein 100≤D≤400.

8. The secondary battery according to claim 1, wherein 0.1≤P≤0.5.

9. The secondary battery according to claim 1, wherein 4≤x≤25.

10. The secondary battery according to claim 1, wherein when observed along a thickness direction of the negative electrode sheet, the each recess is a quadrilateral, and a length of a shortest side of the quadrilateral is D1 mm, wherein 0.02≤D1≤0.5.

11. The secondary battery according to claim 1, wherein when observed along a thickness direction of the negative electrode sheet, the each recess is a quadrilateral, a sum of areas of the quadrilaterals is S1 mm², and an area of the negative electrode material layer is S2 mm², wherein 0.1≤S1/S2≤0.8.

12. The secondary battery according to claim 1, wherein the electrolyte solution further comprises a first component; and the first component comprises at least one selected from the group consisting of fluoroethylene carbonate, difluoroethylene carbonate, vinylene carbonate, and ethylene vinylene carbonate; and
based on the mass of the electrolyte solution, a mass percentage of the first component is W₂%, wherein 0.5≤W₂≤15.

13. The secondary battery according to claim 12, wherein 1≤W₂≤8.

14. An electronic apparatus, comprising a secondary battery; wherein the secondary battery comprises a negative electrode sheet and an electrolyte solution, wherein the electrolyte solution comprises a Formula I compound, the Formula I compound is 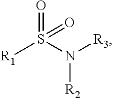
wherein
R₁ is selected from a fluorine atom or a C₁ to C₅ alkyl group that is fully or partially substituted by fluorine, R₂ and R₃ are each independently selected from a C₁ to C₅ alkyl group, and R₂ and R₃ are able to be connected into a ring through a single bond;
based on a mass of the electrolyte solution, a mass percentage of the Formula I compound is W₁%, and 2≤W₁≤50;
the negative electrode sheet comprises a negative electrode current collector and a negative electrode material layer disposed on at least one surface of the negative electrode current collector;
the negative electrode material layer contains silicon element, based on a mass of the negative electrode material layer, a mass percentage of the silicon element is x %, and x≤25;
a thickness of the negative electrode material layer is D μm, a surface of the negative electrode material layer is provided with a plurality of recesses, a depth of each recess is d μm, P=d/D, and P≥0.1; and
0.4≤W₁/(x×P)≤62.5.

15. The electronic apparatus according to claim 14, wherein the Formula I compound comprises at least one of the following compounds:

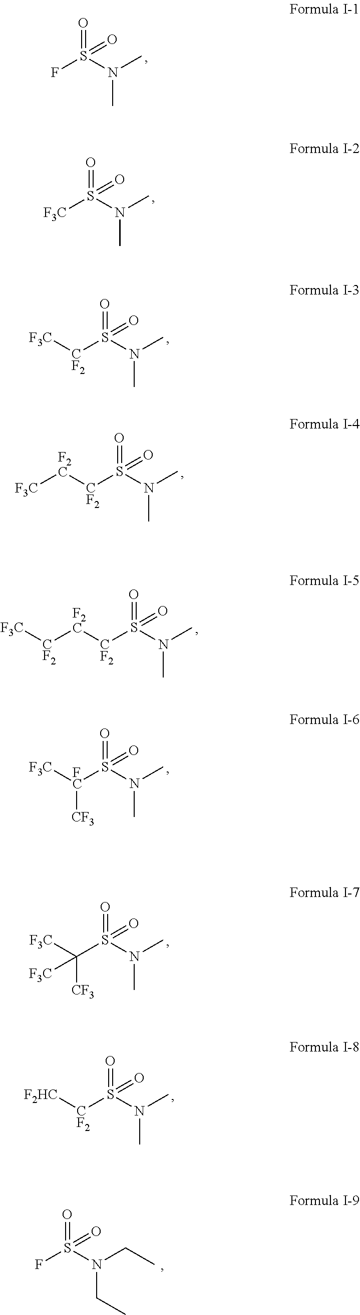

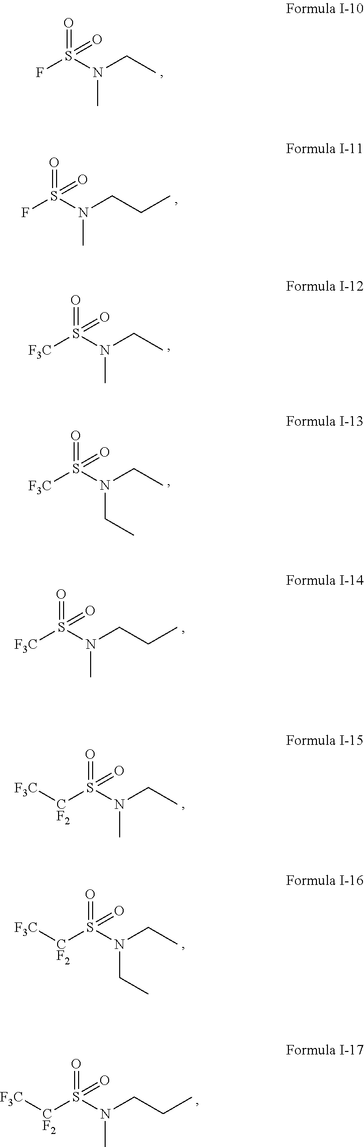

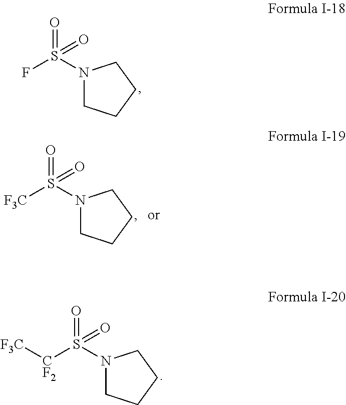 [SMILES: O=S(=O)(F)N1CCCC1 ; O=S(=O)(N1CCCC1)C(F)(F)F ; O=S(=O)(N1CCCC1)C(F)(F)C(F)(F)F]

16. The electronic apparatus according to claim 14, wherein a minimum distance between two adjacent recesses is L μm, wherein 50≤L≤300.

17. The electronic apparatus according to claim 16, wherein 0.05≤W₁/L≤0.25.

18. The electronic apparatus according to claim 14, wherein when observed along a thickness direction of the negative electrode sheet, the each recess is a quadrilateral, and a length of a shortest side of the quadrilateral is D1 mm, wherein 0.02≤D1≤0.5.

19. The electronic apparatus according to claim 14, wherein the electrolyte solution further comprises a first component; and the first component comprises at least one selected from the group consisting of fluoroethylene carbonate, difluoroethylene carbonate, vinylene carbonate, and ethylene vinylene carbonate; and
based on the mass of the electrolyte solution, a mass percentage of the first component is W₂%, wherein 0.5≤W₂≤15.

20. The electronic apparatus according to claim 14, wherein 1≤W₂≤8.
